(19) United States
(12) Patent Application Publication
(10) Pub. No.: US 2014/0196179 A1
(43) Pub. Date: Jul. 10, 2014

(54) ULTRA-COMPACT NANOCAVITY-ENHANCED SCANNING PROBE MICROSCOPY AND METHOD

(71) Applicant: The Trustees of Columbia University in the City of New York, New York, NY (US)

(72) Inventor: Dirk R. ENGLUND, New York, NY (US)

(21) Appl. No.: 14/150,389

(22) Filed: Jan. 8, 2014

Related U.S. Application Data
(63) Continuation of application No. PCT/US2012/048837, filed on Jul. 30, 2012.
(60) Provisional application No. 61/513,818, filed on Aug. 1, 2011.

(51) Int. Cl. G01Q 70/14; G01Q 10/00

(52) U.S. Cl. CPC G01Q 70/14; G01Q 10/00
USPC 850/1; 850/59

(57) ABSTRACT

Techniques for measuring the topography of a surface using a device including a semiconductor slab having a distal end and a base region, and an air slot therein. A sensor tip can be coupled to the slab below the air-slot. A photonic crystal including a lattice pattern with a cavity region defined by a local perturbation in the lattice pattern can be integrated into the semiconductor slab above and below the air slot, thereby providing a split-cavity photonic crystal resonator integrated into the semiconductor slab.

### CROSS-REFERENCE TO RELATED APPLICATIONS

This application is a continuation of International Patent Application No. PCT/US2012/048837 filed Jul. 30, 2012, which is related to U.S. Provisional Application Ser. No. 61/513,818, filed Aug. 1, 2011, each of which is incorporated herein by reference in its entirety and from which priority is claimed.

### STATEMENT OF FEDERALLY SPONSORED RESEARCH OR DEVELOPMENT

This invention was made with government support under Grant No. PECASE # FA9550-12-1-0045, awarded by the Air Force Office of Scientific Research. The government has certain rights in the invention.

### BACKGROUND

The disclosed subject matter relates to sensors for determining surface topographies, nano-scale scanning probes, and techniques.

Atomic force microscopy (“AFM”) is a scanning probe technique with spatial resolution that can be as low as fractions of a nanometer. AFM is ubiquitous in nanoscience, where it can be used to measure and manipulate structures and surfaces far below the diffraction limit of light and indeed below the spatial resolution of most scanning electron microscopes, especially in the vertical dimension. Certain AFM devices use a cantilever with a small tip that physically scans across a surface in contact or scanning mode. The tip's deflection can be measured by monitoring the reflection of a laser beam from the tip surface. This optical setup can require a precisely engineered mechanical assembly for the laser source, alignment optics, and the split-photodiode detection, and can be large, complicated, and expensive.

Accordingly, there is a need for improved devices and methods for nanoscale scanning.

### SUMMARY

In accordance with one aspect of the disclosed subject matter, a device for measuring the topography of a surface is disclosed. In an exemplary embodiment, a device includes a semiconductor slab having a distal end and a base region. An air-slot can be cut into the semiconductor slab. The air-slot can have a proximal end and a distal end. The device can also include a sensor tip, coupled to the semiconductor slab, below the air-slot. The device can further include a photonic crystal. The phonic crystal, which can be integrated into the slab above and below the air-slot, can have a lattice pattern and a cavity region defined by a local perturbation in the lattice pattern. The air-slot can run through the cavity region, thereby splitting the cavity region and providing a split-cavity photonic crystal resonator integrated into the semiconductor slab.

In some embodiments, the device can further comprise a holder. The holder can be coupled to the base region and configured to couple with a piezo scanning device. The sensor tip can have a nm-scale radius of curvature.

In some embodiments, the semiconductor slab can be planar. Additionally, the slab can include either of a drop-filter or a detector. In some embodiments, the air-slot can function as a waveguide and can functionally couple the cavity to the drop-filter. The detector can be coupled to the drop-filter. The slab can also include a light source configured to emit light through the air-slot, which can function as a wave-guide, functionally coupling the light source and the cavity.

In some embodiments the light source can be further configured to emit light through the scanning tip, which can have a nano-scale tip (e.g., a plasmonic tip). The light can be directed into the surface and allows the device to be used as a component in a scanning near-field optical microscope.

In some embodiments the distal end of the air-slot can be contiguous with the distal end of the semi-conductor slab, creating a cantilever region below the air-slot. The sensor tip can be coupled to the semiconductor slab proximate the distal end of the semiconductor slab. In some embodiments either or both of the proximate and distal ends of the air-slot can comprise a cut-out region, increasing flexibility of the slab. In some embodiments the semiconductor slab can comprise one or more cut-out regions, increasing flexibility of the semiconductor slab in a first axis and decreasing flexibility of the semiconductor slab in a second axis.

In accordance with another embodiment, methods of determining the topography of a surface are provided. An exemplary method includes placing a tip of a semiconductor slab having a photonic crystal resonator with a split-cavity region, split by an air-slot, at a first location proximate the surface. An initial resonance frequency of the split-cavity of the optical resonator can be determined, and can correspond with a first level of compression of the cavity. The slab can be advanced across the surface to at least a second location proximate the surface. At least one additional resonance frequency of the split-cavity of the optical resonator corresponding to at least one additional level of compression of the cavity can be determined. A deflection of the tip based on the change from the initial resonance frequency to the at least one additional resonance frequency can be determined.

In some embodiments, the resonance frequency of the split-cavity of the optical resonator can be determined by coupling a resonant optical field into the cavity and measuring the cavity spectrum. In some embodiments, at least one additional resonance frequency of the split-cavity of the optical resonator can be determined by measuring a leakage metric of the cavity with a spectrum analyzer.

In some embodiments, a method of determining the topography of a surface can further include scanning the slab across the surface to a plurality of locations proximate the surface, determining a plurality of resonance frequencies of the split-cavity of the optical resonator, calculating a plurality of deflections of the tip based on the change in resonance frequency from the initial resonance frequency to the plurality of resonance frequencies, and determining the topography of the surface based on the plurality of deflections.

Other aspects and advantages of the subject matter will become apparent from the following description.

### BRIEF DESCRIPTION OF THE DRAWINGS

FIG. 1 is a schematic diagram of a device in accordance with an embodiment of the disclosed subject matter for measuring the topography of a surface.

FIG. 2 is a schematic diagram of a device in accordance with another embodiment of the disclosed subject matter for measuring the topography of a surface.

FIG. 3 is a schematic diagram of a device in accordance with another embodiment of the disclosed subject matter for measuring the topography of a surface.

FIG. 4 is an enlarged schematic diagram of the split-cavity region of a photonic crystal resonator in accordance with an embodiment of the disclosed subject matter.

FIG. 5 is a schematic diagram of a device for measuring the topography of a surface in accordance with an embodiment of the disclosed subject matter.

FIG. 6 is a schematic diagram of a device for measuring the topography of a surface in accordance with another embodiment of the disclosed subject matter.

FIGS. 7a-7d are schematic diagrams of various tip configurations according to certain embodiments of the disclosed subject matter.

FIG. 8 is an electron scanning microscope image of the SCPCR region of a device according to an embodiment of the disclosed subject matter.

FIG. 9 is an electron scanning microscope image of a plurality of devices according to an embodiment of the disclosed subject matter.

FIG. 10 is an optical image of a device according to an embodiment of the disclosed subject matter.

FIG. 11 illustrates a representative plot of G(n, θ, η) for a silicon-based gap mode cavity around 1500 nm in accordance with the disclosed subject matter

FIG. 12 is a flow diagram for a method of determining the topography of a surface according to an embodiment of the disclosed subject matter.

Throughout the drawings, the same reference numerals and characters, unless otherwise stated, are used to denote like features, elements, components or portions of the illustrated embodiments. Moreover, while the disclosed subject matter will now be described in detail with reference to the Figs., it is done so in connection with the illustrative embodiments.

### DETAILED DESCRIPTION

The disclosed subject matter provides methods and devices for measuring the topography of a surface, which can include a semiconductor slab with an optical resonator including a split-cavity photonic crystal resonator (SCPCR) integrated on the semiconductor slab. A sensor tip can be coupled to the slab below the SCPCR. If the sensor tip is deflected during sensing, the SCPCR can be compressed, changing the SCPCR's resonance frequency. This change can be measured and used to calculate the tip's deflection.

When the SCPCR is compressed (shortened), the cavity resonance frequency can increase from a value of w_{c0} to a value of w_{c}. In one embodiment, for example, the change can be measured by observing the cavity leakage on a spectrometer or a spectrum analyzer. Alternatively, resonant light from the cavity can be transmitted via one or more waveguides to a spectrometer or spectrum analyzer. A strong change in the cavity intensity at frequency w_{c0} can be observed if the cavity center line width has changed by more than a cavity line width, D_{w}. The efficiency of the device, which can be given by a figure of merit, FOM, can be given by abs(w_{c0}-w_{c})/D_{w}. The FOM, for example, can be proportional to the cavity's quality factor (Q) to volume (V) ratio, Q/V. Photonic crystal cavities can have high Q/V ratios and therefore can be suited for nanometer scale sensing applications. The deflection of the tip can thus be monitored, enabling sub-nm precision, as described in greater detail below.

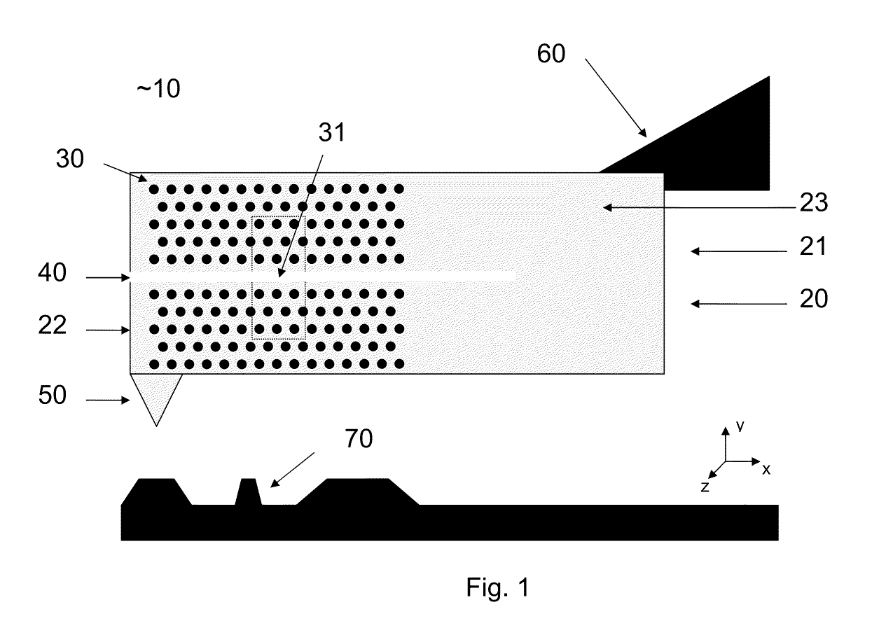

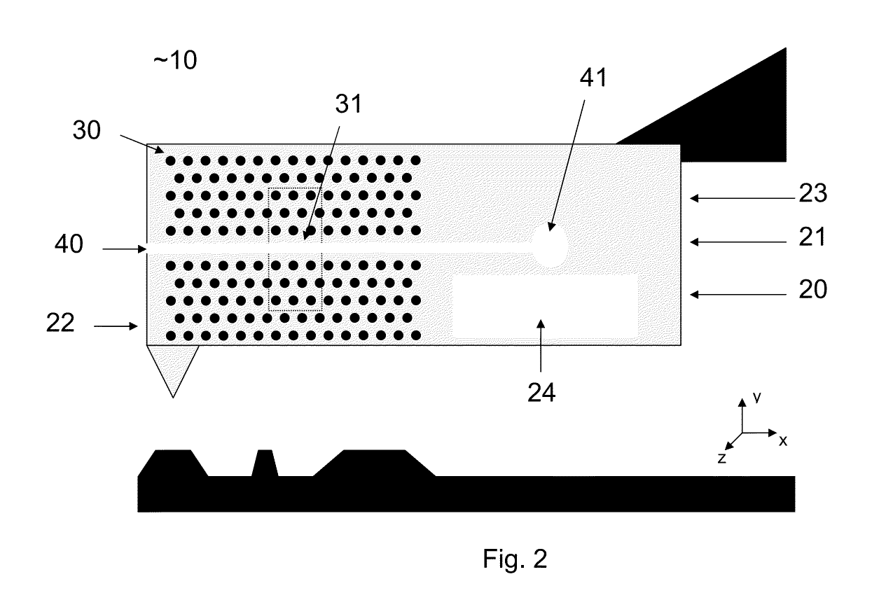

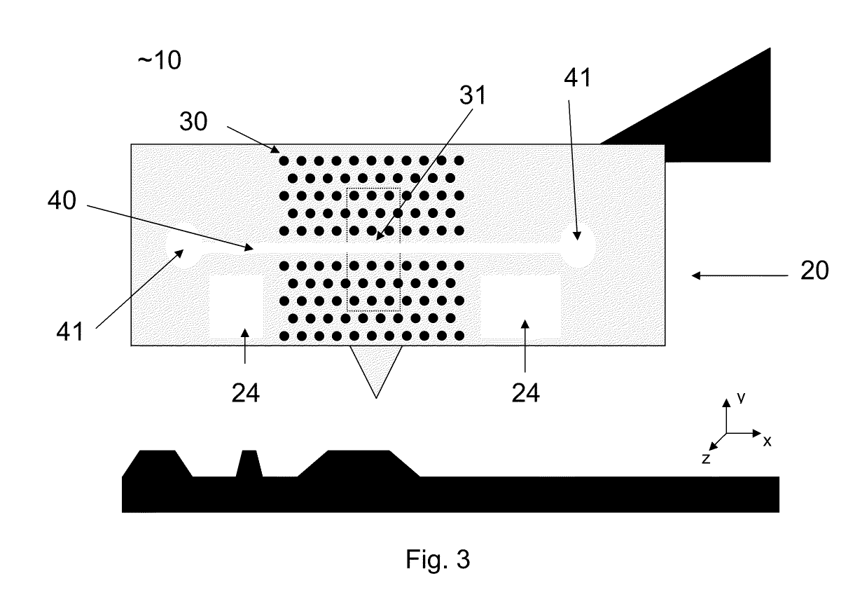

Particular embodiments of a device for measuring the topography of a surface are described below, with reference to FIG. 1, FIG. 2, and FIG. 3, for purposes of illustration, and not limitation.

In accordance with certain embodiments of the disclosed subject matter, device 10 includes a semiconductor slab 20. The semiconductor slab 20 includes a proximal end 21, a distal end 22, and a base region 23. The device 10 can also include a photonic crystal 30 integrated onto the semiconductor slab 20. In one embodiment, the photonic crystal 30 can include a lattice pattern of holes through the semiconductor slab 20. The holes can have a diameter of approximately 50 to approximately 400 nm. A suitable hole diameter can depend on the resonance wavelength λ of the cavity. For example, in a triangular lattice of holes in a high-index membrane such as silicon, the fundamental bandgap can exist from approximately a/λ=0.25 to a/λ=0.33 for a hole radius r=0.3*a, where a is the lattice constant (i.e., distance between holes). The cavity resonance frequency can be anywhere within the bandgap. The hole radius can be calculated from these relations. The photonic crystal 30 can have a cavity region 31, defined by a local perturbation in the lattice pattern.

The cavity region 31 can, for example, be a split-cavity region. For example, the semiconductor slab 20 can be at least partially bisected by an air-slot 40, such that the photonic crystal 30 and the cavity region 31 are integrated into the slab both above and below the air-slot 40. This configuration can result in a SCPCR located within the semiconductor slab 20. In some embodiments, one or both of the photonic crystal 30 and the cavity region 31 can be symmetric about the air-slot 40. The air-slot 40 can be, for example approximately 20 nm to approximately 60 nm wide. The depth of the air-slot 40 can extend through the membrane. The width of the air-slot 40 can be, for example, greater than ten lattice constants, i.e., over 10 a.

A holder 60 can be coupled, for example using adhesives such as UV-curable glue, to base region 23, and adapted to integrate with a conventional AFM device. For example, the holder can be attached to a commercial AFM scanner, or an AFM ‘blank’ which includes the mechanism for mounting the scanner into the commercial AFM holder and a membrane, but can lack the sharp AFM tip. In some embodiments, discussed in greater detail below, the holder 60 can be adapted to integrate with other scanning or sensing devices, including for example, a scanning near-field optical microscope. The holder 60 can be a piezo controlled holder. If sensing tip 50 is brought into contact with surface 70, the cavity region 31 can be deflected (compressed), causing a measurable change in the resonant frequency of the cavity region 31. The term “contact,” as used herein, can include physical interactions between the sensing tip 50 and the surface 70 or other force interactions between the sensing tip 50 and the surface 70, e.g., electromagnetic forces.

With reference to FIG. 1, the distal end of air-slot 40 can be aligned with the distal end 22 of the semiconductor slab 20, creating a cantilever region below the air-slot. Sensing tip 50 can be coupled to the semiconductor slab 20 below the air-slot 40, proximate the distal end 22 of the semiconductor slab 20. The sensing tip can be an extension of the semiconductor slab.

In some embodiments, and with reference to FIG. 3, the distal end of air-slot 40 can terminate before the distal end 22 of semiconductor slab 20. In such embodiments, the sensing tip 50 can be coupled to the semiconductor slab 20 at a more central location. In some embodiments the sensing tip 50 can be located directly below the cavity region 31.

In certain embodiments, and with reference to FIG. 2 and FIG. 3, one or both of the distal and proximal ends of the air-slot 40 can include an air-slot cut-out region 41. The air-slot cut-out regions of FIG. 2 and FIG. 3 are shown as circular cut-outs, but other shapes can be used. In an exemplary embodiments, circular slots can allow for easier fabrication and can reduce internal material stress during flexure. Air-slot cut-out regions 41 can help to increase flexibility of the semiconductor slab 20 along the y-axis, proximate the cavity region 31. Additionally, the semiconductor slab 20 can have one or more cut-out regions 24. The cut-out regions 24 are shown as rectangular cut-outs, but any shape can be used. The cut-out regions 24 are configured to help flexibility in the y-axis while preventing motion in the z-axis.

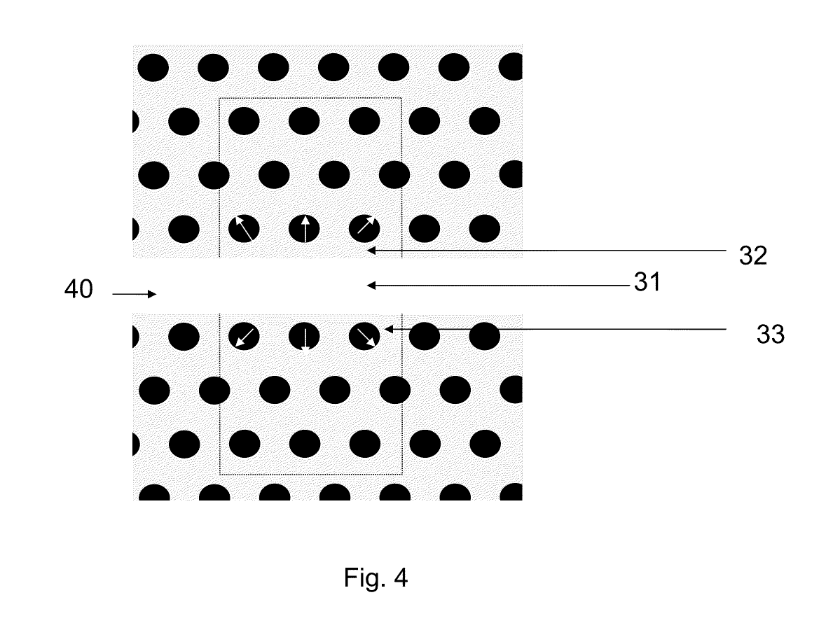

FIG. 4 depicts a schematic of the cavity region 31 of an SCPCR in accordance with the disclosed subject matter. The cavity region 31 can be defined by a local perturbation of the lattice pattern. Air-slot 40 can be disposed through the cavity region 31, splitting the cavity region 31 into a first cavity region 32 and a second cavity region 33.

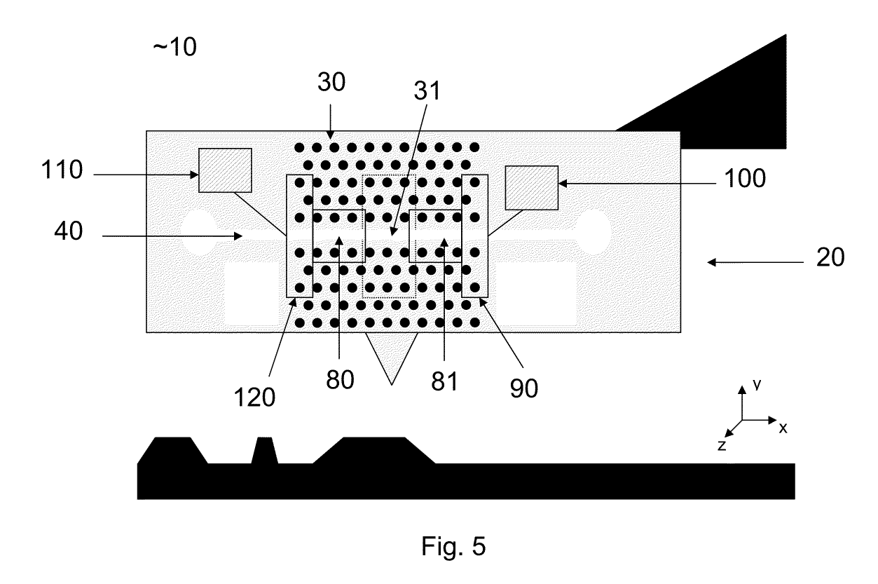

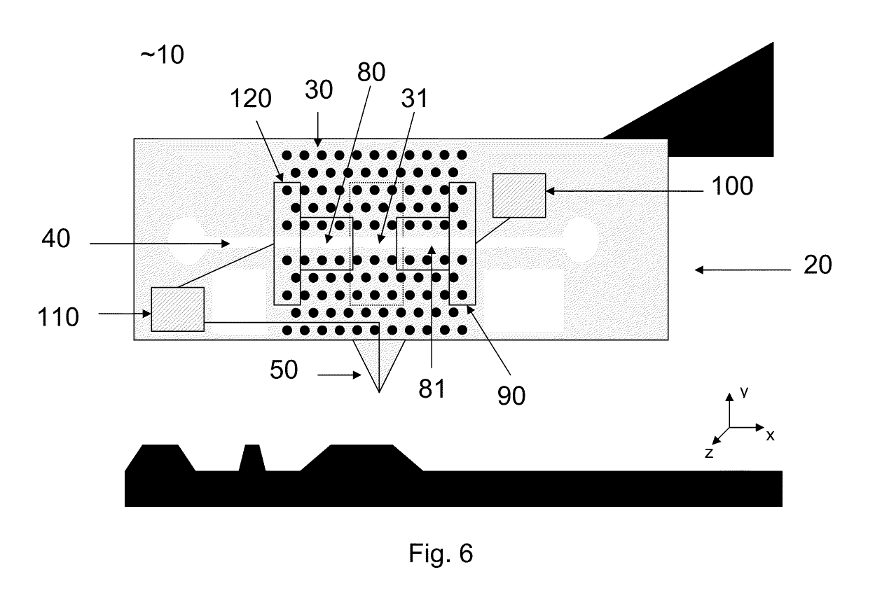

In certain embodiments of the disclosed subject matter, and with reference to FIG. 5 and FIG. 6, a device 10 can include a light source 110 integrated onto the semiconductor slab 20. The light source 110 can deliver light to an input grating 120, which directs a portion of the light through air-slot 40.

The input grating 120 can, for example, include small perturbations on the existing grating of the photonic crystal, at a desired location. For example, in a W1 photonic crystal waveguide in a holey photonic crystal membrane, the grating can include only small dielectric index perturbations to a set of holes near the waveguide region, in such a way as to scatter vertical light into the high-index slab, as disclosed, for example, in M. Toishi, D. Englund, A. Faraon, and J. Vuckovic, High-brightness single photon source from a quantum dot in a grating-integrated nanocavity, Optics Express, Vol 17, pp 14618-14626 (2009). In some instances extra holes adjacent to the existing holes can be introduced, which can reduce fabrication challenges that may be associated with electron beam fabrication of non-circular or very small, isolated perturbations.

Input grating 120 can direct light through waveguide 80 and into cavity region 31. Light emitted from cavity region 31 can travel through waveguide 81 and into filter 90. From filter 90, light can travel along another waveguide to detector 100.

Light source 110 can be a broadband, such as a light emitting diode, supercontinuum laser, fluorescent, or incandescent light source, or narrowband, such as a laser light source. Alternatively the light source can be internal to the photonic crystal, for example the material can be made of a fluorescent material (such as GaAs—InAs quantum wells), or it can have some fluorescent dye or quantum dots deposited on the semiconductor slab 20. The light source 110 can be pumped by electrical carrier injection or by shining a pump laser at the device. For example, with reference to FIG. 6, light source 110 can be configured to direct light towards the input grating 120 and also towards sensing tip 50. The light can then be directed out the sensing tip 50 and into surface 70. This configuration can allow the device 10 to be implemented as an element of a scanning near-field optical microscope (SNOM) and simultaneously as an element in an AFM device. Alternatively, device 10 can be used separately in an AFM device or a SNOM device. In such a configuration, the holder 60 can be configured to integrate with a SNOM device.

Waveguides 80 and 81 can be, for example, regions of the air-slot 40 within the photonic crystal 30, but generally outside the cavity region 31. Waveguides 80 and 81 can be configured to behave as such by, for example, surrounding the desired regions of the air-slot 40 with mirrors.

Filter 90 can be a drop filter or a transmission filter and can be used to convert the frequency of light resonated from the cavity into an intensity, which can then be measured by detector 100. Detector 100 can be a photodiode or other known light detectors.

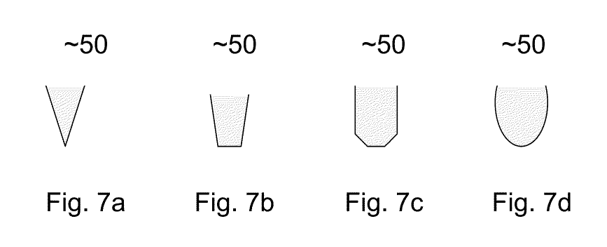

FIGS. 7a-d show schematic diagrams of various sensing tip 50 configurations. Sensing tip 50 can have a nm-scale radius of curvature. In some embodiments, the tip can be fabricated using electron beam lithography. Additionally, for example, anisotropic chemical etching can be used, e.g., potassium hydroxide for silicon substrates. Such etching can be directional with the crystal direction and can lead to clear crystal facets that focus at one points, which can be sub-nm in size.

These techniques can allow for fabrication of a planar AFM tip and a variety of other different shapes. The sensing tip 50 can have a variety of geometries, for example a triangle (FIG. 7a), oval (FIG. 7d) or other (FIGS. 7b and 7c). Sensing tip 50 can be any shape suitable for scanning and is not limited by the shapes depicted in the figures. Alternatively, in some embodiments (e.g., as depicted in FIG. 6) the sensing tip 50 can be adapted to transmit light there through (e.g., a plasmonic tip 50). Different tip geometries can be used for different applications. That is, the shape of the AFM tip can be designed based on, among other things, the hardness of the sample to be imaged and other properties of the target sample. For purposes of illustration and not limitation, a sharp and pointed tip can be used for scanning hard materials at the nm scale. Alternatively, a blunt tip can be used for scanning soft tissue.

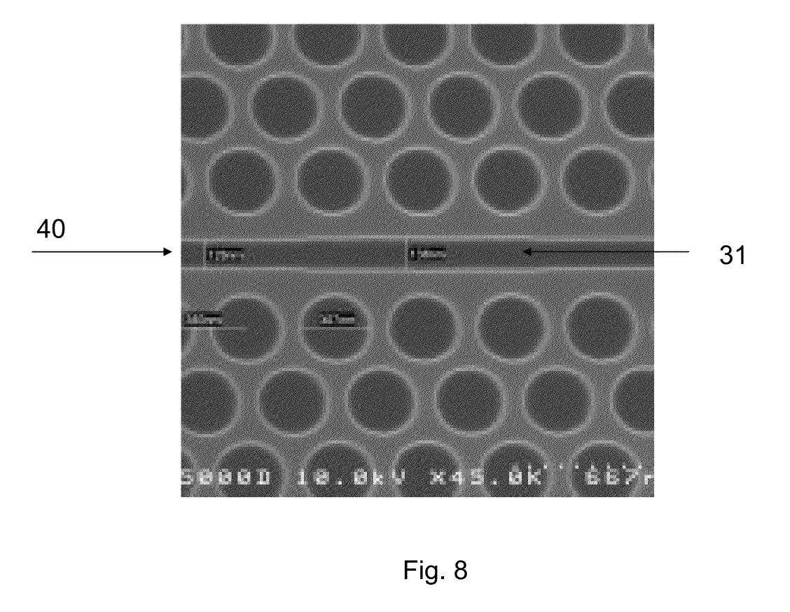

FIG. 8 shows an electron scanning microscope image of the cavity region 31 of a device according the disclosed subject matter. The cavity region is split by the air-slot 40 which creates an SCPCR integrated onto the semiconductor slab.

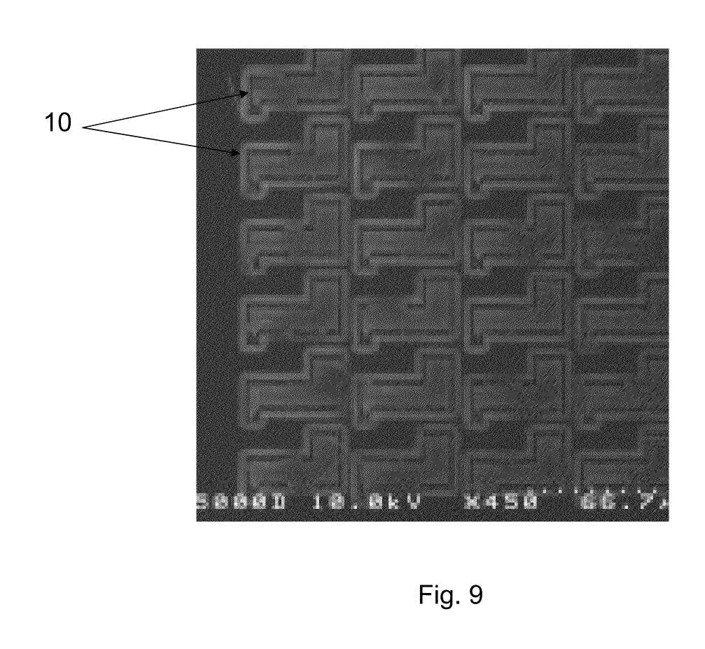

FIG. 9 shows an electron scanning microscope image of a plurality of devices 10 according to the disclosed subject matter. A plurality of devices can be manufactured side-by-side at the same time, as shown in FIG. 9. The devices can be fabricated in bulk from a single semiconductor slab.

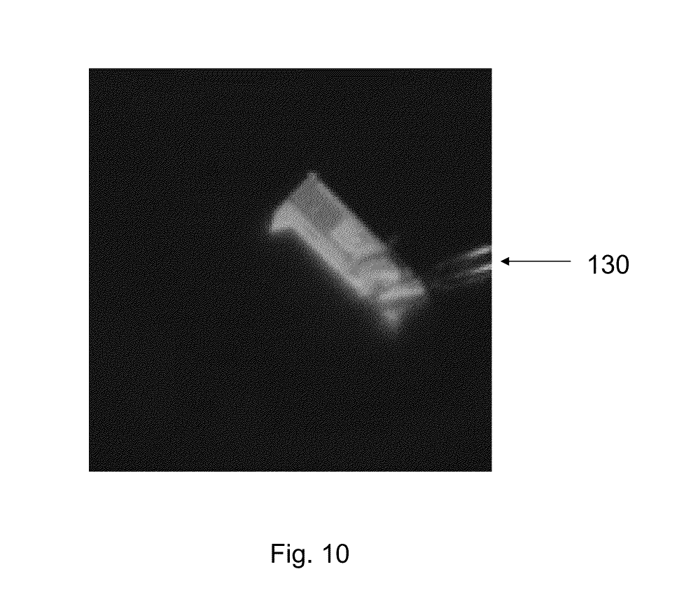

FIG. 10 shows an optical image of the device 10 being held by a holder 130. The holder 130 can allow easy manipulation of the device 10. The devices can be created with a long base region, which can allow the placement of UV curable glue and allow fixation of a holder or tweezers, which can simplify removal of the finished device, as shown in FIG. 10.

The device, including the semiconductor chip and the SCPCR, can be fabricated by a variety of known techniques, including, for example, chemical etching or reactive ion etching. Chemical etching involves applying reactive ions, for example hydrofluoric acid, to selected regions of the surface of the semiconductor chip to dissolve away material providing the desired pattern. In some embodiments, a substrate can be chosen with regard to its propensity to be selectively etched. For example, for a silicon membrane, the substrate can be silicon dioxide, which can be selectively removed with hydrofluoric acid.

In accordance with another aspect of the disclosed subject matter, a method for sensing the topography of a surface will now be described in detail. In one embodiment, for example, the devices described herein can be positioned tip-down over a surface. When the tip is retracted from the surface, the cavity resonance frequency can have an initial value of w_{c0}. When the tip approaches the surface, the cavity can be compressed (shortened), such that that the cavity resonance frequency increases to a value of w_{c}. This change can be monitored with a detector, such as a photodetector, and measured with an AFM control system, providing information about the topography of the surface. With a feed-back loop controlling the cavity height, the tip is scanned relative to the surface, enabling the acquisition of a plurality of values for w_{c}. This can be used to determine a topographical image or can be used for other functions of AFM devices.

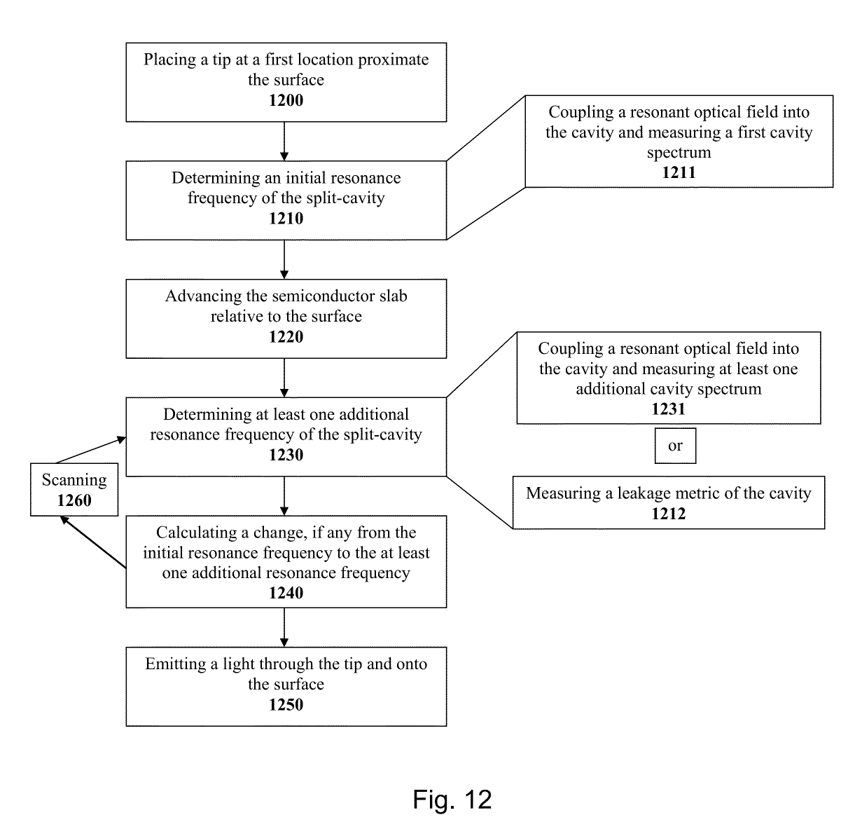

In accordance with another embodiment of the presently disclosed subject matter, methods of determining the topography of a surface are provided. Referring to FIG. 12, an exemplary method can include placing a tip of a semiconductor slab having a photonic crystal resonator with a split-cavity region, split by an air-slot, at a first location proximate the surface (1200). The surface can be, for example, a metal or glass surface. An initial resonance frequency of the split-cavity of the optical resonator can be determined (1210), and can correspond with a first level of compression of the cavity. The slab can be advanced across the surface to at least a second location proximate the surface (1220). At least one additional resonance frequency of the split-cavity of the optical resonator can be determined (1230), and can correspond with at least one additional of compression of the cavity. The change, if any, from initial resonance frequency to the at least one additional resonance frequency can be calculated (1240) and used to determine a corresponding change in topography of the surface.

In some embodiments, determining a first resonance frequency of the split-cavity of the optical resonator (1210) can include coupling a resonant optical field into the cavity and measuring a first cavity spectrum (1211). In some embodiments, determining at least one additional resonance frequency of the split-cavity of the optical resonator (1230) can include coupling a resonant optical field into the cavity and measuring at least one additional cavity spectrum (1231). In some embodiments, determining at least one additional resonance frequency of the split-cavity of the optical resonator (1230) can include measuring a leakage metric of the cavity (1212).

In some embodiments, a method of determining the topography of a surface can further include scanning the slab across the surface (1260) to a plurality of locations proximate the surface, determining a plurality of resonance frequencies of the split-cavity of the optical resonator, calculating a plurality of deflections of the tip based on the change in resonance frequency from the initial resonance frequency to the plurality of resonance frequencies, and determining the topography of the surface based on the plurality of deflections.

For purposes of illustration, and not limitation, the devices disclosed herein can be characterized in accordance with the following description. Additionally, for purposes of illustration, the following cavity parameters can be given as follows: l is the length of the cavity, t is the thickness of the slab, and δ is the shift in the air slot size

The frequency shift induced in the harmonic modes of a system by small changes in the dielectric function of the system can be found through first-order perturbation theory and can be given by:

$${Δω}_{s} = - \frac{{ω}_{0}}{2} \frac{\int {d}^{3} r Δ ∈ ( r ) \vert {E ( r )}^{2} \vert}{\int {d}^{3} r ∈ ( r ) \vert {E ( r )}^{2} \vert} . \qquad ( 1 )$$

Δωₛ/ω₀ can be proportional to −Δλₛ/λ₀ⁱ, where ω₀ and λ₀ represent the mode's unperturbed frequency. In the case where Δωₛ is cavity line width limited, Δωₛ/ω₀ can also proportional to the inverse of the quality factor Q. Owing to a strong confinement of light in the cavity, it can be assumed that the electric field strength is the highest in the cavity region. As such, the lower integral of equation 1 can assume its maximum in the cavity, and the upper integral of equation 1 can assume its maximum where the dielectric function changes (i.e. the cavity moves). Accordingly, for small δ(<<λ₀/2n),

$$\int {d}^{3} r ∈ ( r ) \vert {E ( r )}^{2} \vert \approx {∈}_{0} V \cdot \vert {E ( {r}_{0} )}^{2} \vert = {∈}_{0} tL \frac{{λ}_{0}}{2 n} \vert {E ( {r}_{0} )}^{2} \vert , \\ \int {d}^{3} r Δ ∈ ( r ) \vert {E ( r )}^{2} \vert \approx {∈}_{Si} δ tL \vert {E ( {r}_{0} )}^{2} \vert , and \\ \to \frac{{Δω}_{s}}{{ω}_{0}} \approx - \frac{1}{2} \frac{{∈}_{Si} δ tL \vert {E ( {r}_{0} )}^{2} \vert}{{∈}_{0} tL \frac{{λ}_{0}}{2 n} \vert {E ( {r}_{0} )}^{2} \vert} = - \frac{δ {n}^{3}}{{λ}_{0}} ( {∈}_{Si} / {∈}_{0} = {n}_{Si}^{2} ) . \qquad ( 2 )$$

From Equation 2, the smallest (cavity line width limited) displacement that can be detected for a given Q can be identified as follows:

$$\begin{matrix}\frac{{n}^{3} {δ}_{min}}{{λ}_{0}} = \frac{1}{Q} \to {δ}_{min} \\ = \frac{{λ}_{0}}{{n}^{3} Q} .\end{matrix} \qquad ( 3 )$$

Equations 2 and 3 can satisfy the small δ criteria imposed earlier, and can hold if,

$${δ}_{min} = \frac{{λ}_{0}}{{n}^{3} Q} << \frac{{λ}_{0}}{2 n}$$

$$or$$

$$\frac{1}{{n}^{2} Q} << \frac{1}{2} \to 2 << {n}^{2} Q .$$

Accordingly, the assumptions hold for even moderate Q's. For example, for a silicon cavity at 1.5 μm with a Q of 10³, δₘᵢₙ can provide a sub-angstrom resolution of:

$$\frac{1500 nm}{{3.5}^{3} \times {10}^{3}} = .035 nm .$$

However, equations 1-3 can be inaccurate for shifting boundaries as the normal component of the electric field to the boundary is discontinuous across it. Considering such discontinuities, the proper perturbation theory result can be given by:

$$\begin{matrix}Δ {ω}_{s} = - \frac{{ω}_{0}}{2} \frac{〈 E \vert \frac{d ∈}{d α} \vert E 〉}{〈 E \vert ∈ \vert E 〉} \\ = \frac{- {ω}_{0}}{2} \frac{\int {d}^{3} r \frac{d h}{d α} [ Δ {∈}_{12} ( r ) {\vert {E}_{\vert \vert} \vert}^{2} - Δ ( {∈}_{12}^{- 1} ( r ) ) {\vert {D}_{⊥} \vert}^{2} ]}{\int {d}^{3} r ∈ ( r ) \vert {E ( r )}^{2} \vert} ,\end{matrix} \qquad ( 4 )$$

accounting for high-index contrast boundaries. The following assumptions can be used to evaluate the integrals of equation 4: (1) in the plane of the cavity, it can be assumed that E_{z} is small compared to Eₓ and E_{y} and can be ignored; (2) the length of the region where maximum field intensity exists in the cavity is given by cₗ and the fraction of that region in the air is given by θ; (3) Eₓ=ηE_{y}, Eₓ^{Si}=Eₓ^{Air} and D_{y}^{Si}=D_{y}^{Air}. Eₓ and E_{y} are uniform throughout the cavity region (with E_{y} satisfying the boundary condition); (4) h(α) is the function that describes how the boundary of the leaves shifts parameterized by α (e.g., h(α)=x₀+α); and (5) Δ∈₁₂=∈₁−∈₂=∈₀ (∈ᵣ−1) and Δ(∈₁₂⁻¹)=∈₁⁻¹−∈₂⁻¹=−(∈ᵣ−1)/∈ᵣ∈₀ since ∈₁=∈_{Si} and ∈₂=∈₀.

Accordingly, the integral in the numerator can be given by:

$$\begin{matrix}\int {d}^{3} r \frac{d h}{d α} [ \begin{matrix}Δ {∈}_{12} ( r ) {\vert {E}_{\vert \vert} \vert}^{2} - \\ Δ ( {∈}_{12}^{- 1} ( r ) ) {\vert {D}_{⊥} \vert}^{2}\end{matrix} ] \approx \int {d}^{3} r [ \begin{matrix}{∈}_{0} ( {∈}_{r} - 1 ) {( {E}_{x}^{2} )}_{Si} + \\ \frac{{∈}_{r} - 1}{{∈}_{r} {∈}_{0}} {( {D}_{y}^{2} )}_{Si}\end{matrix} ] \\ = δ tL [ \begin{matrix}{e}_{0} ( {∈}_{r} - 1 ) {( {E}_{x}^{2} )}_{Air} + \\ \frac{{∈}_{r} - 1}{{∈}_{r} {∈}_{0}} {( {D}_{y}^{2} )}_{Air}\end{matrix} ] \\ = δ tL [ \begin{matrix}{∈}_{0} ( {∈}_{r} - 1 ) {{η}^{2} ( {E}_{y}^{2} )}_{Air} + \\ \frac{{∈}_{r} - 1}{{∈}_{r} {∈}_{0}} {∈}_{0}^{2} {( {E}_{y}^{2} )}_{Air}\end{matrix} ] \\ = δ tL {∈}_{0} ( {∈}_{r} - 1 ) \frac{{η}^{2} {∈}_{r} + 1}{{∈}_{r}} {( {E}_{y}^{2} )}_{Air} .\end{matrix}$$

The integral in the denominator can be given by:

$$\int {d}^{3} r ∈ ( r ) \vert {E ( r )}^{2} \vert \approx {c}_{l} θ tL {∈}_{0} {\vert E \vert}_{air}^{2} + {c}_{l} ( 1 - θ ) tL {∈}_{Si} {\vert E \vert}_{Si}^{2}$$

$$\begin{matrix}{\vert E \vert}_{Air}^{2} = {E}_{x}^{2} + {E}_{y}^{2} \\ = ( {η}^{2} + 1 ) {( {E}_{y}^{2} )}_{Air}\end{matrix}$$

$$\begin{matrix}{\vert E \vert}_{Si}^{2} = {( {E}_{x}^{2} )}_{Si} + {( {E}_{y}^{2} )}_{Si} \\ = {( {E}_{x}^{2} )}_{Air} + \frac{{∈}_{0}^{2}}{{∈}_{Si}^{2}} {( {E}_{y}^{2} )}_{Air} \\ = ( \frac{{n}^{4} {η}^{2} + 1}{{n}^{4}} ) {( {E}_{y}^{2} )}_{Air} \to {c}_{l} tL {∈}_{0} [ \begin{matrix}θ ( {η}^{2} + 1 ) + \\ ( 1 - θ ) {∈}_{r} ( \frac{{n}^{4} {η}^{2} + 1}{{n}^{4}} )\end{matrix} ] {( {E}_{y}^{2} )}_{Air} .\end{matrix}$$

Combining the above representation of the integral in the numerator and the integral in the denominator, and using the relation that ∈ᵣ=n² can yield the following:

$$\frac{{Δω}_{s}}{{ω}_{0}} = - \frac{1}{2} \frac{δ}{{c}_{l}} \frac{( {n}^{2} - 1 ) ( {η}^{2} {n}^{2} + 1 )}{{n}^{2} θ ( {η}^{2} + 1 ) + ( 1 - θ ) ( {n}^{4} {η}^{2} + 1 )} . \qquad ( 5 )$$

While equation 5 is significantly more complex than equation 2, the two are similar when the appropriate values for equation 5 are entered. For example, inserting cₗ=λ₀/2n, η=1, and θ=1 provides

$$\frac{{Δω}_{s}}{{ω}_{0}} = - \frac{δ}{{λ}_{0}} \frac{{n}^{4} - 1}{4 n} .$$

Equation 5 can provide a more accurate representation of reality as compared to equation 2. The minimum absolute shift can thus be given by:

$$\begin{matrix}\frac{1}{Q} = - \frac{1}{2} \frac{δ}{{c}_{l}} \frac{( {n}^{2} - 1 ) ( {η}^{2} {n}^{2} + 1 )}{\underbrace{{n}^{2} θ ( {η}^{2} + 1 ) + ( 1 - θ ) ( {n}^{4} {η}^{2} + 1 )}_{{G ( n , θ , η )}^{- 1}}} \to {δ}_{min} \\ = \frac{2 {c}_{l}}{Q} G ( n , θ , η ) .\end{matrix} \qquad ( 6 )$$

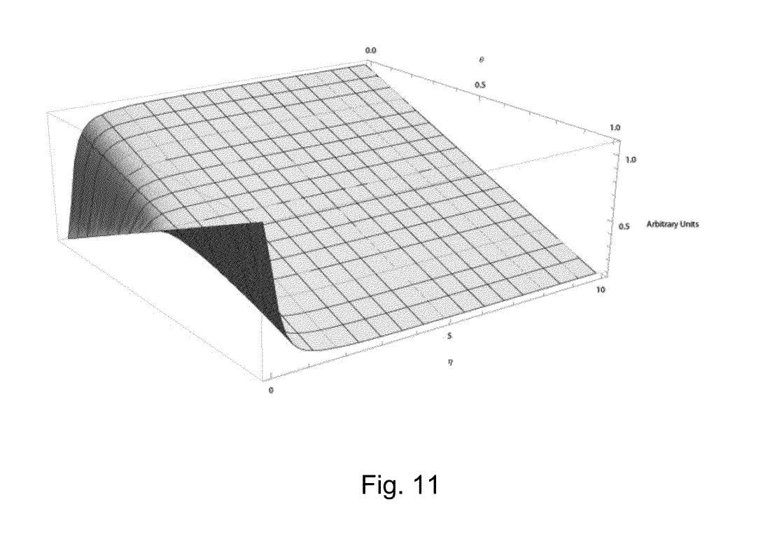

FIG. 11 illustrates a representative plot of G(n, θ, η) for a silicon-based gap mode cavity around 1500 nm in accordance with the disclosed subject matter. Accordingly, G can be analyzed as follows:

$$\frac{\partial G}{\partial θ} = 0$$

when η=n⁻¹. From FIG. 12, for η>n⁻¹, θ=0 maximizes G. When 0<η<n⁻¹, θ=1 maximizes G. In the limit where there is only Eₓ, η→∞ and

$$\frac{lim G}{η \to ∞} = \frac{{n}^{2} ( 1 - θ ) + θ}{{n}^{2} - 1} ,$$

which is maximized when θ=0 or

$$G = \frac{{n}^{2}}{{n}^{2 } - 1} . θ = 1$$

minimizes it to give

$$G = \frac{1}{{n}^{2 } - 1} .$$

Similarly, in the limit where there is only E_{y}, η→0 and

$$\frac{lim G}{η \to 0} = \frac{θ ( {n}^{2} - 1 ) + 1}{{n}^{2} - 1} ,$$

which is maximized when θ=1 to give

$$G = \frac{{n}^{2}}{{n}^{2 } - 1} . θ = 0$$

minimizes it to give

$$G = \frac{1}{{n}^{2 } - 1} .$$

Q∝G and can be applied to the above results. For a mode with Eₓ only, Q is maximized when θ=0. This situation can be interpreted as the mode requiring a node at the air slot. For a mode with only E_{y}, Q is maximized when θ=1 or when there is an antinode in the slot.

The small δ criteria for equation 6 can also be satisfied as follows:

$${δ}_{min} = \frac{2 {c}_{l}}{Q} G ( n , θ , η ) << {c}_{l} \to 2 {G}_{max} << Q \to 2 \frac{{n}^{2}}{{n}^{2} - 1} << Q .$$

This holds for moderate Q (assuming that n is within a reasonable range, as the index contrast becomes smaller, achieving a high Q becomes much harder). The minimum detection limit can thus be bounded, and for cₗ=λ₀/2n:

$$\frac{{λ}_{0}}{Q} \frac{1}{{n}^{3} - n} \leq {δ}_{min} \leq \frac{{λ}_{0}}{Q} \frac{n}{{n}^{2} - 1} .$$

When evaluated with the previous parameters, there can be a large range for the minimum detection limit: 0.038 nm≦δₘᵢₙ≦0.467 nm

For purpose of illustration and not limitation, cavity performance in detecting shifts can be evaluated using a dimensionless figure of merit (FOM). An appropriate figure of merit can measure how well a cavity can shift its resonance for a given change in cavity length. Taking detection limitations into considerations, the shift is defined in terms of the original cavity line width:

$$\begin{matrix}FOM ≡ \frac{1}{δ} \frac{Δ λ}{Δ {λ}_{0}} , \\ Q = \frac{{λ}_{0}}{Δ {λ}_{0}} \frac{Δ {λ}_{s}}{{λ}_{0}} = - \frac{Δ {ω}_{s}}{{ω}_{0}} = \frac{δ}{2 {c}_{1}} {G}^{- 1} , and & ( 7 ) \\ FOM = \frac{1}{δ} \frac{Δ {λ}_{s}}{ {λ}_{0}} \frac{{λ}_{0}}{Δ {λ}_{0}} = \frac{1}{δ} \frac{δ}{2 {c}_{l}} {G}^{- 1} Q = \frac{Q}{2 {c}_{l}} {G}^{- 1} , & ( 8 )\end{matrix}$$

where Δλₛ is the shift in the cavity resonance, λ₀ is the resonant wavelength, and Δλ0 is the original cavity line width. Thus, the FOM can be bound for known maximum and minimum values of G:

$$\frac{Δ {λ}_{s}}{ {λ}_{0}} = \frac{1}{2} \frac{1}{{c}_{l} G} δ \to Δ {λ}_{th} = \frac{{λ}_{0}}{2 {c}_{l} G} \frac{1}{{v}_{mech}} \sqrt{\frac{{k}_{B} T}{m}}$$

While the presently disclosed subject matter has been particularly described with reference to exemplary embodiments thereof, it will be understood by those skilled in the art that various modifications and alterations may be made without departing from the spirit and scope of the invention. Accordingly, the disclosed embodiments are considered merely illustrative, and the disclosed subject matter is limited in scope only as specified in the appended claims.

1. A device for measuring the topography of a surface, comprising:
a semiconductor slab having a distal end and a base region, and an air-slot therein, the air-slot having a proximal end and a distal end;
a sensor tip, coupled to the slab, below the air-slot; and
a photonic crystal including a lattice pattern and having a cavity region defined by a local perturbation in the lattice pattern, the photonic crystal being integrated into the semiconductor slab above and below the air-slot;
wherein the air-slot runs through the cavity region, thereby splitting the cavity region and providing a split-cavity photonic crystal resonator integrated into the semiconductor slab.

2. The device of claim 1, further comprising a holder, coupled to the base region and configured for coupling with a piezo scanning device.

3. The device of claim 1, wherein the sensor tip comprises a sensor tip having a nm-scale radius of curvature.

4. The device of claim 3, wherein the semiconductor slab comprises a planar slab.

5. The device of claim 3, wherein the semiconductor slab further comprises:
a drop-filter; and
wherein the air-slot comprises an air-slot adapted to function as a waveguide, coupling the cavity and the drop-filter.

6. The device of claim 5, further comprising a detector, coupled to the drop-filter, configured to measure a property of light resonated by the split cavity photonic crystal resonator.

7. The device of claim 6, wherein the detector comprises a photodiode.

8. The device of claim 1, further comprising a light source; and
wherein the air-slot comprises an air-slot adapted to function as a waveguide, coupling the light source and the cavity.

9. The device of claim 8, wherein the light source comprises a fluorescent material.

10. The device of claim 8, wherein the sensor tip comprises a sensor tip having a nano-scale radius of curvature; and wherein
the light source is further configured to emit a light through the sensor tip and provide a light source for a scanning near-field optical microscope.

11. The device of claim 1, wherein distal end of the air-slot is contiguous with the distal end of the semiconductor slab, creating a cantilever region below the air-slot.

12. The device of claim 11, wherein the sensor tip is coupled to the semiconductor slab proximate the distal end of the slab.

13. The device of claim 1, wherein the proximate end of the air-slot comprises a cut-out region configured to increase flexibility of the semiconductor slab.

14. The device of claim 1, wherein the distal end of the air-slot comprises a cut-out region configured to increase flexibility of the semiconductor slab.

15. The device of claim 1, wherein the semiconductor slab further comprises at least one cut-out region configured to increase flexibility of the semiconductor slab in a first axis and to decrease flexibility of the semiconductor slab in a second axis.

16. A method of determining the topography of a surface using a semiconductor slab including a photonic crystal resonator having a split-cavity region split by an air-slot therein, comprising:
placing a tip of the semiconductor slab at a first location proximate the surface;
determining an initial resonance frequency of the split-cavity region corresponding to a first level of compression of the cavity;
advancing the semiconductor slab relative surface to at least a second location proximate the surface;
determining at least one additional resonance frequency of the split-cavity region corresponding to at least one additional level of compression of the cavity; and
calculating a change, if any, from the initial resonance frequency to the at least one additional resonance frequency to thereby determine a deflection of the tip and a corresponding change in the topography of the surface.

17. The method of claim 16, wherein determining the initial resonance frequency comprises coupling a resonant optical field into the cavity and measuring a first cavity spectrum; and
determining at least one additional resonance frequency comprises coupling a resonant optical field into the cavity and measuring at least one additional cavity spectrum.

18. The method of claim 16, wherein determining at least one additional resonance frequency comprises measuring a leakage metric of the cavity.

19. The method of claim 16, further comprising emitting a light through the tip and into the surface, thereby providing a light for a scanning near-field optical microscope.

20. The method of claim 16, further comprising scanning the semiconductor slab across the surface to at least a plurality of locations proximate the surface;
determining a plurality of resonance frequencies of the split-cavity region corresponding to the plurality of locations;
calculating a plurality of deflections of the tip based on the change in resonance frequency from the initial resonance frequency to the plurality of resonance frequencies; and
determining the topography of the surface based on the plurality of deflections.
